(19) United States
(12) Patent Application Publication
(10) Pub. No.: US 2025/0021863 A1
(43) Pub. Date: Jan. 16, 2025

(54) GENERATION OF A REDUCED MACHINE LEARNING MODEL

(71) Applicant: NEC Corporation Of America, Herzlia (IL)

(72) Inventors: Yaacov HOCH, Ramat-Gan (IL); Maya COHEN MAIMON, Holon (IL); Ekaterina SHELENKOVA, Netanya (IL)

(73) Assignee: NEC Corporation Of America, Herzlia (IL)

(21) Appl. No.: 18/219,774

(22) Filed: Jul. 10, 2023

(51) Int. Cl. G06N 20/00

(52) U.S. Cl. CPC G06N 20/00

(57) ABSTRACT

There is provided a method of generating a reduced ML model, comprising: obtaining a sample dataset, extracting global features from the sample dataset, applying a feature selection process for selecting a first subset of the global features, analyzing a classification performance of the ML model fed the first subset, to identify an error in classification by the ML model, identifying a subset of the sample dataset related to the error, extracting second features from the subset of the sample data, applying the feature selection process for selecting a second subset of the second features, and creating a reduced version of the ML model, comprising an ensemble of: a first ML model component trained by applying the first subset of global features to the sample dataset, and a second ML model component trained by applying the second subset of features to the subset of the sample data related to the error.

### BACKGROUND

The present invention, in some embodiments thereof, relates to machine learning models and, more specifically, but not exclusively, to systems and methods for creating reduced versions of a machine learning model.

Machine learning models may be fed features extracted from input data. The larger the number of features that are extracted and fed into the machine learning model, the higher the expected accuracy of classification. However, extraction of a larger number of features is computationally expensive. Reducing the number of features that are extracted improves computational efficiency of a computer executing the machine learning model.

### SUMMARY

According to a first aspect, a computer implemented method of generating a reduced version of a ML model, comprises: obtaining a sample dataset, extracting a plurality of global features from the sample dataset, applying a feature selection process for selecting a first subset of the plurality of global features, analyzing a classification performance of the ML model fed the first subset, to identify an error in classification by the ML model, identifying a subset of the sample dataset related to the error, extracting a plurality of second features from the subset of the sample data, applying the feature selection process for selecting a second subset of the plurality of second features, and creating a reduced version of the ML model, comprising an ensemble of: a first ML model component trained by applying the first subset of the plurality of global features to the sample dataset, and a second ML model component trained by applying the second subset of the plurality of features to the subset of the sample data related to the error.

According to a second aspect, a computer implemented method of inference by a reduced version of a ML model, comprises: obtaining input data, extracting a first subset of features from the input data, feeding the first subset of features into a first ML model component of the reduced version of the ML model, obtaining a first classification outcome from the first ML model component, analyzing the first classification outcome to determine whether an error in classification occurred, in response to determining the error, extracting a second subset of features from the input data, feeding the second subset of features into a second ML model component of the reduced version of the ML model, and obtaining a second classification outcome comprising a resolution to the error of the first classification outcome from the second ML model, wherein the reduced version of the ML model is created according to the first aspect.

According to a third aspect, a system for generating a reduced version of a ML model, comprises: at least one processor executing a code for: obtaining a sample dataset, extracting a plurality of global features from the sample dataset, applying a feature selection process for selecting a first subset of the plurality of global features, analyzing a classification performance of the ML model fed the first subset, to identify an error in classification by the ML model, identifying a subset of the sample dataset related to the error, extracting a plurality of second features from the subset of the sample data, applying the feature selection process for selecting a second subset of the plurality of second features, and creating a reduced version of the ML model, comprising an ensemble of: a first ML model component trained by applying the first subset of the plurality of global features to the sample dataset, and a second ML model component trained by applying the second subset of the plurality of features to the subset of the sample data related to the error.

In a further implementation form of the first, second, and third aspects, during inference, input data is first fed into the first ML model component to obtain a classification outcome, and in response to the classification outcome denoting the error in classification comprising ambiguity in the classification outcome, the input data is fed into the second ML model component to obtain a resolution to the classification outcome.

In a further implementation form of the first, second, and third aspects, the feature selection process comprises defining a target function according to the plurality of global features or second features and a correlation with an expected outcome of the ML model being fed the plurality of global features or second features, and finding a minimum of the target function, the minimum representing the first subset or the second subset.

In a further implementation form of the first, second, and third aspects, further comprising applying a quantum annealer based process for finding the minimum of the cost function.

In a further implementation form of the first, second, and third aspects, the error comprises at least two classification categories of a plurality of classification categories for which the ML model performance incorrect classification at a rate above a threshold, wherein the input data is fed into the second ML model component when the first ML model component classifies input data into the at least two classification categories, wherein the second ML model component classifies the input data into one of the at least two classification categories.

In a further implementation form of the first, second, and third aspects, the at least two classification categories are merged into a single classification category, and the first model ML component is trained to classify the input data into the single classification category or other classification categories of the plurality of classification categories.

In a further implementation form of the first, second, and third aspects, the second ML model component resolves ambiguity of the single classification category by classifying the input data into one of the at least two classification categories merged into the single classification category.

In a further implementation form of the first, second, and third aspects, further comprising computing a confusion matrix of the ML model fed the first subset to identify the error.

In a further implementation form of the first, second, and third aspects, further comprising: measuring a baseline classification performance of the ML model fed the plurality of global features, measuring the classification performance of the ML model fed the first subset, evaluating the classification performance of the ML model fed the first subset relative to the baseline classification performance to determine significant degradation in performance, and wherein the identification of the error in classification is in response to the determination of significant degradation in performance.

In a further implementation form of the first, second, and third aspects, further comprising: analyzing the classification performance of the second ML model component fed the second subset, to identify a second error in classification by the second ML model component, identifying a second subset of the sample dataset related to the second error, extracting a plurality of third features from the second subset of the sample data, applying the feature selection process for selecting a third subset of the plurality of third features, and creating a third ML model component for inclusion in the reduced version of the ML model, the third ML model component trained by applying the third subset of features to the sample dataset, wherein input data is fed into the third ML model component when the second ML model component performs the second error in classification.

In a further implementation form of the first, second, and third aspects, further comprising: iterating the analyzing the classification performance, the identifying the subset, the extracting, the applying the feature selection process, and the creating the reduced version, for creating a hierarchical tree of ML model components, wherein each lower level ML model component is for resolving classification ambiguity of a higher level ML model component.

In a further implementation form of the first, second, and third aspects, the plurality of second features are the same as the plurality of global features.

In a further implementation of the second aspect, the error in classification occurred when the first classification outcome comprises a single classification category representing a merger of a plurality of different classification categories, wherein the first ML model component is unable to accurately classify into one of the plurality of different classification categories, wherein the second ML model component accurately classifies into one of the plurality of different classification categories.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of components of system for generating a reduced version of a ML model, and/or for inference by the reduced version of the ML model, in accordance with some embodiments of the present invention;

FIG. 2 is a flowchart of a method of generating a reduced version of a ML model, in accordance with some embodiments of the present invention;

FIG. 3 is a flowchart of a method of inference by the reduced version of the ML model, in accordance with some embodiments of the present invention;

FIG. 4 is a schematic of multiple confusion matrices created for an ML model trained on a full set of features and trained on a subset of selected features, in accordance with some embodiments of the present invention;

FIG. 5 is a schematic of multiple confusion matrices created for an ML model trained on a training dataset that excludes data from the two devices that were confused, in accordance with some embodiments of the present invention;

FIG. 6 is a schematic of two confusion matrices created for an ML model trained on a training dataset of data from the two devices that were confused, in accordance with some embodiments of the present invention; and

FIG. 7 is a schematic of multiple confusion matrices created for an ML model ensemble that includes a first ML model component trained to distinguish between multiple devices for which two devices are inaccurately classified, and a second ML model component trained to distinguish between the two devices that are inaccurately classified by the first ML model component, in accordance with some embodiments of the present invention.

### DETAILED DESCRIPTION

The present invention, in some embodiments thereof, relates to machine learning models and, more specifically, but not exclusively, to systems and methods for creating reduced versions of a machine learning model.

An aspect of some embodiments of the present invention relates to systems, methods, computing devices, and/or code instructions (e.g., stored on a data storage device and executable by one or more processors) for generating a reduced version of an original ML model. The reduced version of the ML model may be predicted to have a classification performance that is similar to the original ML model (e.g., within a tolerance range) where the reduced version uses fewer features extracted from a dataset for input into the ML model. The reduced version of the ML model, which uses fewer classification features, is implemented using fewer computational resources, lower utilization of computational resources, and/or in a shorter processing time, in comparison to the original ML model that uses a full set of global features.

A processor(s) obtains a sample dataset. Multiple global features are extracted from the sample dataset. A feature selection process is applied for selecting a first subset of the global features. A classification performance of the ML model fed the first subset, is analyzed, to identify an error in classification by the ML model. A subset of the sample dataset related to the error is identified. Second features are extracted from the subset of the sample data. The feature selection process is applied for selecting a second subset of the second features. A reduced version of the ML model is created. The reduced version includes an ensemble that includes a first ML model component and a second ML model component. The first ML model component is trained by applying the first subset of the global features to the sample dataset. The second ML model component is trained by applying the second subset of the features to the subset of the sample data related to the error. The first ML model component is designed to have a performance classification accuracy for classifying into certain outcomes (e.g., categories) and less accurate for classifying into other outcomes. The second ML model component is designed to have a performance classification accuracy for classifying into the outcomes for which classification performance of the first ML model component is less accurate. The ML model components of the ensemble may be arranged in a hierarchical tree, where the second ML model component is used when the first ML model component classifies into the outcomes where performance accuracy is reduced. It is noted that there may be three or more ML model components in the ensemble, arranged in the hierarchical tree.

Optionally, a quantum annealer based process is used for the feature selection process. The quantum anneal based process enables fast and/or computationally efficient execution of the feature selection process, enabling for feature selection to be performed multiple times, for example for generating multi-level ensembles with multiple ML model components. In contrast existing approaches of feature selection take a considerable amount of time and/or require significant utilization of processing resources. Therefore, feature selection using standard approaches cannot be done iteratively, and is not necessarily practical for computing multi-level ensembles with multiple ML model components.

It is noted that classification categories described herein are a not necessarily limiting example of an outcome of the ML model. Other outcomes of ML models may be used as alternatives to the classification categories, for example, segmentation of images, generated text, generated audio, numerical values, metadata, and the like.

An aspect of some embodiments of the present invention relates to systems, methods, computing devices, and/or code instructions (e.g., stored on a data storage device and executable by one or more processors) for inference by a reduced version of a ML model, such as the multi-level ML model components of the ML ensemble described herein. A processor(s) obtains input data. A first subset of features is extracted from the input data. The first subset of features is fed into the first ML model component of the reduced version of the ML model. A first classification outcome is obtained from the first ML model component. The first classification outcome is analyzed to determine whether an error in classification occurred, for example, the first ML model component classified the first subset of features into a classification category that includes multiple sub-classification categories for which the first ML model cannot accurately distinguish between. In response to determining the error, a second subset of features is extracted from the input data. The second subset of features is fed into a second ML model component of the reduced version of the ML model. A second classification outcome is obtained from the second ML model component. The second classification outcomes includes a resolution to the error of the first classification outcome. For example, the second classification outcomes includes an accurate classification into one of the multiple sub-categories that are included into the category for which the first ML model component cannot accurately distinguish between.

At least some implementations of the systems, methods, computing devices, and/or code instructions (e.g., stored on a data storage device and executable by one or more processors) described herein address the technical problem of creating a reduced version of a machine learning model, which uses fewer extracted features. Feature selection is dimensionality reduction technique used as a preprocessing step in machine learning workflows. The feature selection process selects the most important features. A supervised method selects the best features for target variables, by selecting features most relevant to the target function and/or a diverse set of features. Using feature selection to obtain a reduced machine learning model (that uses fewer features) can reduce computational cost, improve computational performance, and/or interpretation but sometimes the accuracy can deteriorate. When the number of extracted features is reduced too much, the machine learning model may be unable to correctly differentiate between different outcomes, such as between two classification categories that are similar. At least some implementations of the systems, methods, computing devices, and/or code instructions described herein improve the technical field of machine learning, by providing approaches for creating reduced ML models that use fewer extracted features, while enabling accurate distinction between outcomes such as different classification categories.

At least some embodiments of the systems, methods, computing devices, and/or code instructions described herein address the aforementioned technical problem, and/or improve upon the aforementioned technical field, by iteratively applying a feature selection process to select a subset of features used by a machine learning model. For errors in classification occurring when the ML model uses the subset of features, such as error in distinguishing between two categories, another subset of features may be found to create another ML model that distinguishes between the two categories, optionally only between the two categories. A ML model ensemble may be created, where a higher level ML model component performs an initial classification into categories which are accurately classified by the higher level ML model component. A lower level ML model component may perform another classification into categories which are not accurately classified by the higher level ML model component. The lower level ML model component may distinguish between classification categories that are not accurately distinguished by the higher level ML model component. The ML model ensemble may including multiple ML model components, for example, 2, 5, 10, 25, 50, 100, 200 or more, each designed to distinguish between unique classification outcomes (e.g., classification categories). Each ML model component is a reduced version, using fewer extracted features, while providing high accuracy similar to using all extracted features. The reduced version of the ML model improves computational efficiency of a computing device executing the ML model components in comparison to running the ML model with full set of extracted features. Fewer processing resources are required, processing time is reduced, and/or smaller memory resources are used, by using the selected set of features with the reduced ML model ensemble in comparison to the full set of features used with the non-reduced ML model.

The features may be selected using an optimization engine which is computationally efficient, for example, based on a quantum annealer process. The quantum annealer is a machine designed to efficiently solve optimization problems. An example of the optimization engine based on the quantum annealer process is a Dwave annealer. The quantum annealer operates by exploiting quantum features of particles to find the global minimum of a cost function.

The quantum annealer based process enables performing feature selection multiple times, optionally a large number of times, to discover which subset of features to use to create the ML model ensemble. Standard feature selection approaches which are very close and/or require significant computational resources cannot be practically used to select the features, since creation of the ML model ensemble would take an impractically long time and/or tie up processing resources.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

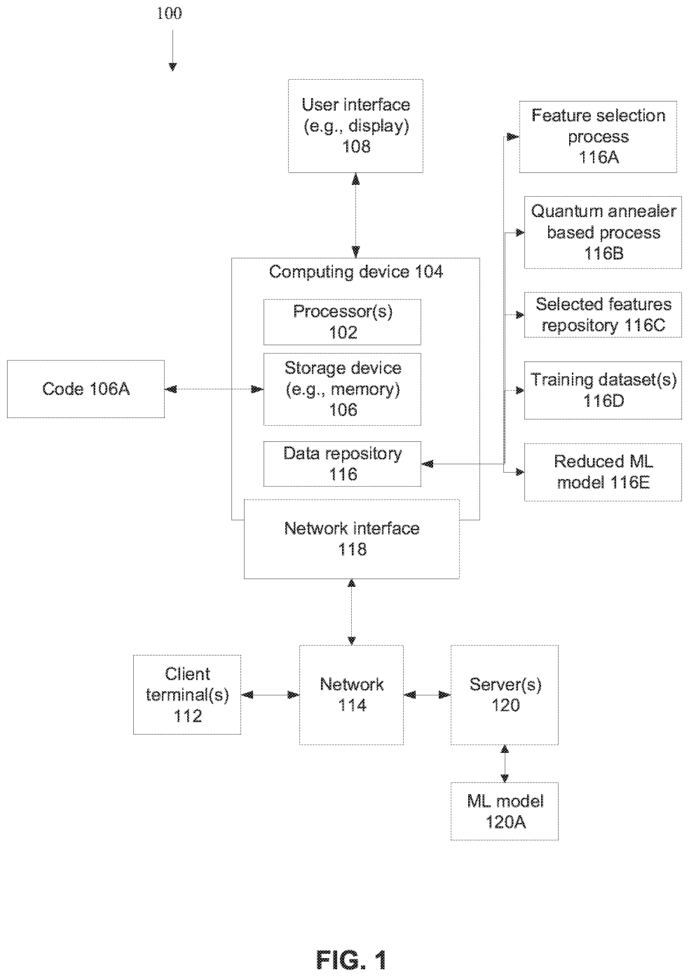

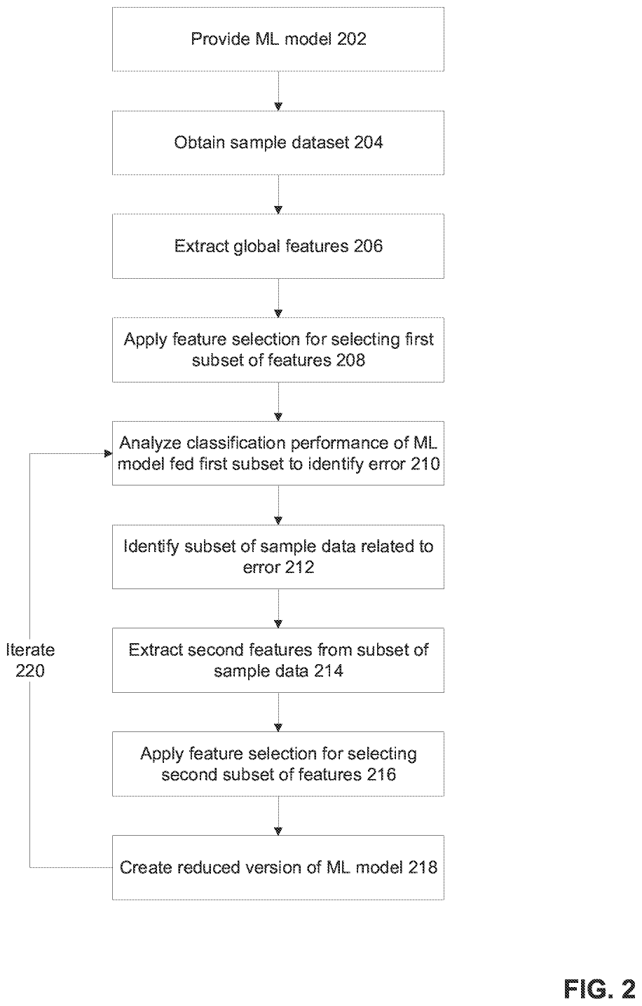

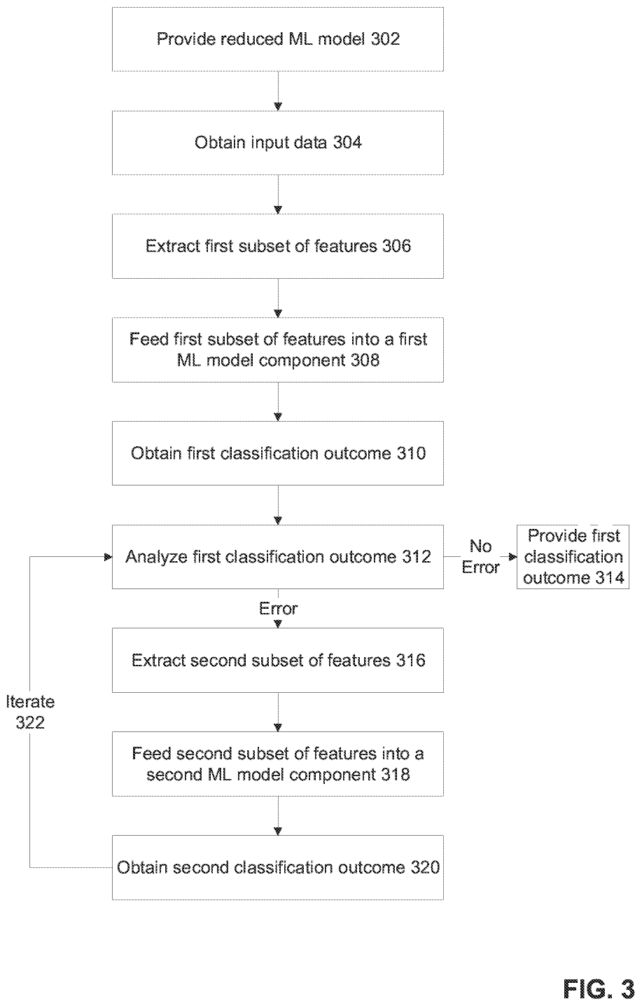

Reference is now made to FIG. 1, which is a block diagram of components of system 100 for generating a reduced version of a ML model, and/or for inference by the reduced version of the ML model, in accordance with some embodiments of the present invention. Reference is also made to FIG. 2, which is a flowchart of a method of generating a reduced version of a ML model, in accordance with some embodiments of the present invention. Reference is also made to FIG. 3, which is a flowchart of a method of inference by the reduced version of the ML model, in accordance with some embodiments of the present invention.

System 100 may implement the acts of the method described with reference to FIGS. 2-3 and/or other methods described herein, by processor(s) 102 of a computing device 104 executing code instructions 106A stored in a storage device 106 (also referred to as a memory and/or program store).

Computing device 104 may be implemented as, for example, a client terminal, a server, a single computer, a group of computers, a computing cloud, a virtual server, a virtual machine, a mobile device, a desktop computer, a thin client, a Smartphone, a Tablet computer, a laptop computer, a wearable computer, glasses computer, and a watch computer.

Multiple architectures of system 100 based on computing device 104 may be implemented. In an exemplary implementation of a centralized architecture, computing device 104 storing code 106A, may be implemented as one or more servers (e.g., network server, web server, a computing cloud, a virtual server) that provides services (e.g., one or more of the acts described with reference to FIGS. 2-3 and/or other methods described herein) to one or more client terminals 112 and/or server(s) 120 over a network 114, for example, providing software as a service (Saas) to the client terminal(s) 112 and/or server(s) 120, providing software services accessible using a software interface (e.g., application programming interface (API), software development kit (SDK)), providing an application for local download to the client terminal(s) 112 and/or server(s) 120, and/or providing functions using a remote access session to the client terminals 112 and/or server(s) 120, such as through a web browser.

In an example of a centralized architecture, multiple different ML models 120A may be running on server(s) 120. Computing device 104 may create a reduced ML model 116E for each ML model 120A, by using a feature selection process 116A to select features that resolve classification errors, as described herein. Reduced ML model 116E may be created by using using a quantum annealer based process 116B to solve feature selection process 116A for selecting the features that can be used to resolve classification errors. Training dataset(s) 116D may be created using the selected features, for training reduced ML model 116E, which may be an ensemble of multiple ML model components, as described herein.

In another example of a localized architecture, computing device 104 may include locally stored software (e.g., code 106A) that performs one or more of the acts described with reference to FIGS. 2-3 and/or other methods described herein. ML model 120A may be running on computing device 104. Computing device 104 locally selects the features from the features used by ML model 120A, by using a feature selection process 116A, optionally using a quantum annealer based process 116B, as described herein. Computing device 104 may locally create training dataset(s) 116D using the selected features, and/or locally create reduced ML model 116E, as described herein.

Processor(s) 102 of computing device 104 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include multiple processors (homogenous or heterogeneous) arranged for parallel processing, as clusters and/or as one or more multi core processing devices. Processor(s) 102 may be arranged as a distributed processing architecture, for example, in a computing cloud, and/or using multiple computing devices. Processor(s) 102 may include a single processor, where optionally, the single processor may be virtualized into multiple virtual processors for parallel processing, as described herein.

Data storage device 106 stores code instructions executable by processor(s) 102, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Storage device 106 stores code 106A that implements one or more features and/or acts of the method described with reference to FIGS. 2-3 and/or other methods described herein when executed by processor(s) 102.

Computing device 104 may include a data repository 116 for storing data, for example, storing one or more of a feature selection process 116A that selects a best subset of features, a quantum annealer based process 116B for quickly performing feature selection, a selected subset of features repository 116D that stores the selected features, training dataset(s) 116D which may be created based on the selected subset of features, and the created reduced ML model(s) 116E which may be created by training on training dataset(s) 116D, and the like, as described herein. Data repository 116 may be implemented as, for example, a memory, a local hard-drive, virtual storage, a removable storage unit, an optical disk, a storage device, and/or as a remote server and/or computing cloud (e.g., accessed using a network connection).

Computing device 104 may include a network interface 118 for connecting to network 114, for example, one or more of, a network interface card, a wireless interface to connect to a wireless network, a physical interface for connecting to a cable for network connectivity, a virtual interface implemented in software, network communication software providing higher layers of network connectivity, and/or other implementations.

Network 114 may be implemented as, for example, the internet, a local area network, a virtual private network, a wireless network, a cellular network, a local bus, a point to point link (e.g., wired), and/or combinations of the aforementioned.

Computing device 104 and/or client terminal(s) 112 include and/or are in communication with one or more physical user interfaces 108 that include a mechanism for a user to enter data (e.g., provide test data 124 for input into ML model 120A) and/or view data (e.g., view detected classification errors), optionally within a GUI. Exemplary user interfaces 108 include, for example, one or more of, a touchscreen, a display, a keyboard, a mouse, and voice activated software using speakers and microphone.

Referring now back to FIG. 2, at 202, a machine learning model is accessed. The machine learning model has been pre-trained on a training dataset. The ML model may be in used for inference of data, for example, a real time production model.

A machine learning model refers to code stored on a data storage device, that when executed, causes a processor to generate an outcome in response to an input of data. The outcome may be, for example, a prediction, a classification category, a number, a label, and the like. The ML model is trained on a training dataset. The ML model may be trained on labeled data, where the input data is accompanied by the correct output or target value (also referred to as supervised learning). Alternatively or additionally, the ML model may be trained to discover patterns or structures in the data without explicit labels (also referred to as unsupervised learning). Exemplary architectures of ML models include one or combination of: a detector architecture, a classifier architecture, a pipeline combination of one or more architectures described herein, neural networks of various architectures (e.g., convolutional, fully connected, deep, encoder-decoder, recurrent, transformer, graph, generative), support vector machines (SVM), logistic regression, k-nearest neighbor, decision trees, boosting, random forest, a regressor, and/or any other commercial or open source package allowing regression, classification, dimensional reduction, supervised, unsupervised, semi-supervised, and/or reinforcement learning (e.g., q-learning, deep q-networks (DQN)).

At 204, a sample dataset is obtained.

The sample dataset may be a real dataset that is designated for input into the ML model for inference. Alternatively, the sample dataset may be a ‘fake’ dataset of no real significance, for example, generated by a data generator to have a certain distribution, for example, a distribution based on real datasets that are fed into the ML model.

The sample dataset may be, for example, numerical values, metadata, text, signals outputted by sensors, images, vectors, arrays, and the like.

At 206, global features are extracted from the sample dataset. The global features may be the same full set of features that are extracted from real datasets that are fed into the ML model.

At 208, a feature selection process is applied for selecting a subset of the global features, sometimes referred to herein as a first subset of selected features.

The selected features may be diverse, for example, significantly different from one another. The selected features may be, for example, about 1%, or 5%, or 10% of the full set of global features, or other values.

The number of selected features may be evaluated, for example, by trial and error, and/or based on an estimate (e.g., computed by a processor executing code). For example, the number of selected features may be selected for significantly improving performance of a computing device executing the ML model (e.g., reduced processing time, reduced processor utilization, reduced memory requirements) while enabling creation of the ML model ensemble with high accuracy, as described herein.

Optionally, the feature selection process is implemented by defining a target function. The target function may be defined according to the global features and a correlation with an expected outcome of the ML model being fed the global features. A minimum of the target function, representing the first subset of selected features is found. It is noted that alternatively the target function may be set up such that the maximum denotes the first subset of selected features.

Optionally, a quantum annealer based process is used for finding the minimum (or maximum) of the target function. The quantum annealer based process makes it feasible and/or practical to iteratively run the feature selection process (e.g., during iterations as described with reference to 218) such as to create a multi-level ML model ensemble and/or wide ML model ensemble, by enabling the feature selection process to be run during a feasible time frame (e.g., order of seconds or minutes) on standard computational resources.

The feature selection process may be automatically converted to, and/or defined in, a mathematical notion referred to as QUBO (quadratic unconstrained binary optimization). The quantum annealer finds the minimum and/or maximum, which indicates the selected features.

At 210, a classification performance of the ML model fed the first subset of selected features may be measured. The classification performance may be analyzed to identify an error in classification by the ML model.

The classification performance may be measured, for example, by splitting the dataset into multiple sub-datasets. For example, when the dataset includes packets generated by multiple different internet of things (IoT) devices, each sub-dataset includes packets generated by one IoT device. The first subset of selected features may be extracted from the multiple sub-datasets. For example, the same subset of selected features are extracted from each of the different sub-datasets and fed into the ML model. For example, when one of the features is packet loss rate, the packet loss rate is determined for each of the different IoT devices. Alternatively, classification performance is estimated for the first subset of selected features obtained from the dataset as a whole (e.g., single dataset). For example, when the dataset includes packets generated by multiple different internet of things (IoT) devices, the dataset may include packets over multiple time intervals from the different IoT devices. The packets from different IoT devices obtained over each time interval are iteratively fed into the ML model.

Optionally, the error in classification occurs for two or more classification categories of multiple classification categories classified by the ML model. The error may be inability of the ML model to accurately distinguish between the two or more classification categories, for example, classifying into a first category instead of into a second category.

The performance of classification of the ML model, optionally accuracy, for the two or more categories may be below a threshold, while the performance of classification of the ML model (e.g., accuracy) for the other categories (excluding the two or more categories) may be above the threshold. The threshold may represent, for example, a dividing line between accuracy of classification that is considered correct classification, and accuracy of classification that is considered incorrect and/or undeterminable. The threshold may be, for example, about 60%, or 70%, or 80%, or other values. In another example, the performance of the ML model is determined to be incorrect classification at a rate above the threshold for the two or more classification categories.

Optionally, a confusion matrix of the ML model fed the first subset of selected features is generated. The confusion matrix may be analyzed to identify the error.

Optionally, a baseline classification performance of the ML model fed the global features is measured, for example, accuracy of classification. The classification performance of the ML model fed the first subset of selected features (e.g., accuracy of classification) may be evaluated relative to the baseline classification performance. The evaluation may be performed to determine whether there is a significant degradation in classification performance of the ML model using the first subset of selected features in comparison to the global features, for example, significant decrease in performance, for example, from above the threshold to below the threshold, and/or a decrease of, for example, at least about 10%, or 20%, or 25%, or 30%, or other values. The error in classification may be determined in response to the determination of significant degradation in performance based on the evaluation.

At 212, a subset of the sample dataset related to the error is identified. The subset of the sample dataset may be determined by mapping the first subset of features that caused the error in classification back to the dataset. For example, the dataset may be divided into sub-datasets, where each sub-dataset is classified into a certain classification category. The sub-datasets which are incorrectly classified by the ML model may be identified. For example, the dataset includes packets generated by multiple different internet of things (IoT) devices, such as 6 IoT devices. The ML model, when fed the first subset of features, is found to be unable to correctly classify devices 3 and 5, i.e., 2 of the 6 devices. The packets generated by devices 3 and 5 are identified.

At 214, second features are extracted from the subset of the sample dataset. The second features may be the same as the global features which were extracted from the sample dataset. Alternatively, the second features are a subset of the global features which are relevant for the subset of the sample dataset, for example, some of the global features may be irrelevant. Alternatively, the second features are generated and/or determined for the subset of the sample dataset, for example, hand crafted features and/or automatically generated.

At 216, the feature selection process is applied for selecting a second subset of the second features.

Optionally, the feature selection process is implemented by defining the target function according to the second features and a correlation with an expected outcome of the ML model being fed the second features. The minimum (or maximum) of the target function representing the selected second subset of the second features may be found, optionally by the quantum annealer based process, for example, as described with reference to 208 of FIG. 2.

At 218, a reduced version of the ML model is created. The reduced version of the ML model may be implemented as an ensemble of multiple ML model components. There may be at least two ML model components, although more may be implemented as described herein. The ML model ensemble may include a first ML model component and a second ML model component. The first ML model component may be trained by applying the first subset features selected from the global features to the sample dataset, and/or to other datasets that are suitable for training. The second ML model component may be trained by applying the second subset of features (selected from the second features), to the subset of the sample data related to the error.

Optionally, the two or more classification categories which the ML model incorrectly classifies may be merged into a single classification category. The first ML model component is trained to classify the input data into the single classification category or into one of the other classification categories. The second ML model is trained to classify (optionally only) into the two or more classification categories included in the merged single classification category. This enables creating a specialized second ML model component that resolves ambiguity of the single classification category by classifying the input data into one of the two or more classification categories merged into the single classification category.

During inference, input data is first fed into the first ML model component to obtain a classification outcome. In response to the classification outcome denoting the error in classification indicating ambiguity in the classification outcome, the input data is fed into the second ML model component to obtain a resolution to the classification outcome.

The error may be two or more classification categories of multiple classification categories for which the ML model performance indicates incorrect classification at a rate above the threshold. The input data is fed into the second ML model component when the first ML model component classifies input data into the two or more classification categories which are determined to be erroneously classified. The second ML model component classifies the input data into one of the two or more classification categories.

The ML model ensemble may be implemented as a hierarchical tree of ML model components. Each lower level ML model component is for resolving classification ambiguity of a higher level ML model component. In other words, features extracted from data may be fed into a ML model component at the root. When the ML model fails to correct classify the data, another set of features is extracted and fed into a lower level ML model component designed to correctly distinguish between classification categories where the higher level ML model component failed to provide accurate classification. Multiple levels and/or multiple ML model components at the same level may be generated. For example, where the ML model component fails to classify between different categories, a different lower ML model component may be generated for each erroneous classification.

At 220, features described with reference to 210-218 may be iterated for defining additional levels of selected features that can be used to accurately distinguish between classification categories where the ML model erroneously classifies the classification categories. Another ML model component of the ensemble may be created, to define another lower level and/or at another pre-existing level.

In each iteration, the ML model may be fed another subset of features to identify another classification error, and another level of features is selected to distinguish between the incorrectly classified categories. During the iterations, the terms first and second may be replaced with subsequent numbering according to the iteration number. Another ML model component of the ensemble may be created during the iterations.

Alternatively, features 210-216 are first iterated, to determine which classification categories are erroneously classified, and the selected subsets of features that enable accurate classification. Then 218 may be implemented for creating multiple ML model components for creating an ensemble.

An example of a third iteration is now described. Additional iterations may be similarly implemented, by increasing the numbering of the ML model components and/or features. At 210, the classification performance of the second ML model component fed the second subset is analyzed, to identify a second error in classification by the second ML model component. At 212, a second subset of the sample dataset related to the second error is identified. At 214, third features are extracted from the second subset of the sample data. At 216, the feature selection process is applied for selecting a third subset of the third features. At 218, a third ML model component is created for inclusion in the reduced version of the ML model, i.e., the ensemble. The third ML model component is trained by applying the third subset of features to the sample dataset. The input data is fed into the third ML model component when the second ML model component performs the second error in classification.

Referring now back to FIG. 3, at 302, the reduced version of the ML model, i.e., the ML model ensemble with multiple ML model components, is trained as described with reference to FIG. 2, and/or the trained ML model (e.g., as described with reference to FIG. 2) is accessed.

At 304, input data for feeding into the reduced version of the ML model is obtained.

At 306, a first subset of features is extracted from the input data. The first subset of extracted features is defined according to the first subset of features that were selected, optionally using the quantum annealer based process, as described with reference to 208 of FIG. 2.

At 308, the first subset of features is fed into the first ML model component of the reduced version of the ML model.

At 310, a first classification outcome is obtained from the first ML model component.

At 312, the first classification outcome may be analyzed to determine whether an error in classification occurred.

The error in classification may occur when the first classification outcome is a single classification category representing a merger of multiple different classification categories for which the first ML model component is unable to accurately classify into one of the different classification categories.

At 314, no classification error has been determined. The first ML model component classified into one of the multiple classification categories for which classification performance is high. The first ML model component classified into a classification category that is different than the single merged classification category. The classification category classified by the first ML model component is provided as the classification outcome of the reduced version of the ML model.

At 316, the error in classification has been determined. The first ML model component may have classified into the single classification category.

In response to the error occurring, a second subset of features is extracted from the input data. The second subset of features is defined according to the second subset of features that were selected, optionally using the quantum annealer based process, as described with reference to 216 of FIG. 2.

At 318, the second subset of features is fed into the second ML model component of the reduced version of the ML model.

At 320, a second classification outcome is obtained from the second ML model. The second ML model component is predicted to accurately classify into one of the different classification categories that are included in the single merged category classified by the first ML model component.

The second classification outcome represents a resolution to the error of the first classification outcome.

The second classification outcome is provided, for example, presented on a display, saved on a data storage device, forwarded to another computing device, and/or fed into an executing process.

At 322, one or more features described with reference to 312-320 may be iterated. The iterations may be performed for a multi-level ensemble of three or more ML model components, for example, to iteratively resolve errors at higher levels by lower levels.

Various embodiments and/or aspects of the present disclosure as delineated hereinabove and as claimed in the claims section below find experimental and/or calculated support in the following examples.

### EXAMPLES

Reference is now made to the following examples, which together with the above descriptions illustrate some embodiments of the invention in a not necessarily limiting fashion.

Inventors evaluated network data of different internet of things (IoT) devices: Amazon Echo Look, Amazon Echo Plus, Google OnHub, LG Smart TV, Nest Cam Ring Doorbell, Samsung SmartThings Hub, and Smart WiFi Plug.

A machine learning model, implemented as a Random Forest architecture, was trained to classify the network traffic into one of the IoT device, i.e., to determine to which of the devices the network traffic is related to. The dataset of network traffic was from 2020 and 2021.

1246 network data features were generated, after preprocessing.

A feature selection process was applied to the full feature set to obtain a first subset of features. A quantum annealer based process was used to implement the feature selection. However, using the reduced set of selected features reduced the accuracy of the random forest model.

A confusion matrix was created, revealing an error in classification between two of the multiple other categories.

Another feature selection process using the quantum annealer based process was applied to the data corresponding to the two categories which are confused by the random forest model. A second subset of features for differentiating between the two categories was selected.

A first ML model component was trained using the first subset of features. The first ML model component classifies data into one less category than the number of categories based on the number of devices. The two confused categories are treated as a single unresolved category.

A second ML model component was trained using the second subset of features. In response to the first ML model component classifying data into the single unresolved category, the second ML model component classifies the data into one of the two categories that were merged into the single unresolved category of the first ML model component. The second ML model component is used to resolve classification ambiguity between the two categories that cannot be accurately resolved by the first ML model component.

The ML model ensemble that uses the first ML model component and the second ML model component, which uses the selected subsets of features, is more computationally efficient than a ML model using the full set of features.

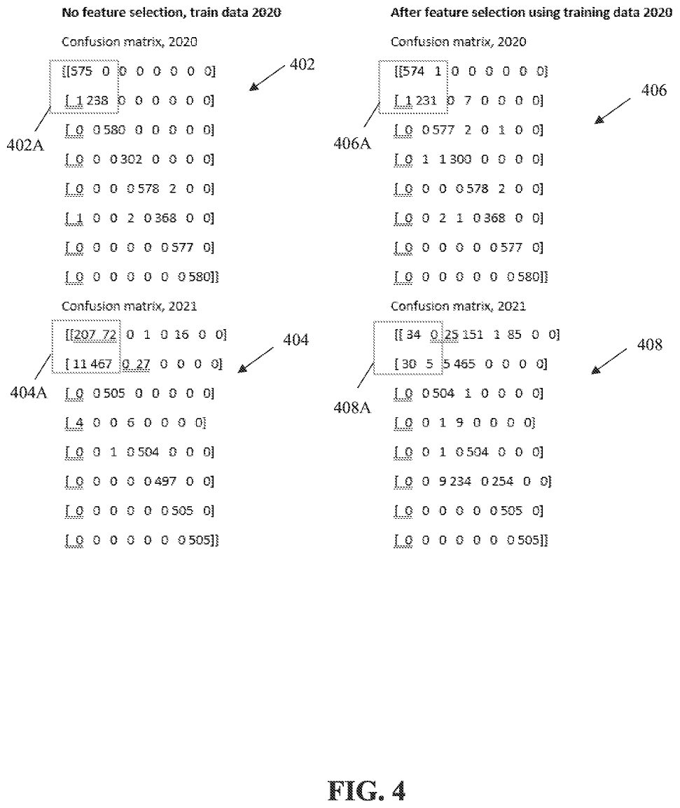

Reference is now made to FIG. 4, which is a schematic of multiple confusion matrices created for an ML model trained on a full set of features and trained on a subset of selected features, in accordance with some embodiments of the present invention. The rows and columns represent the different IoT devices.

Confusion matrix 402 is created for the ML model trained on the full set of features, using 2020 training data.

Confusion matrix 404 is created for the ML model trained on the full set of features, using 2021 training data.

Confusion matrix 406 is created for the ML model trained on a subset of selected features, using 2020 training data.

Confusion matrix 408 is created for the ML model trained on a subset of selected features, using 2021 training data.

The errors mostly occurred for two devices, “Amazon Echo Look” and “Amazon Echo Plus”, marked by boxes 402A, 404A, 406A, and 408A. Mostly likely the error was due to the two devices being from the same manufacturer.

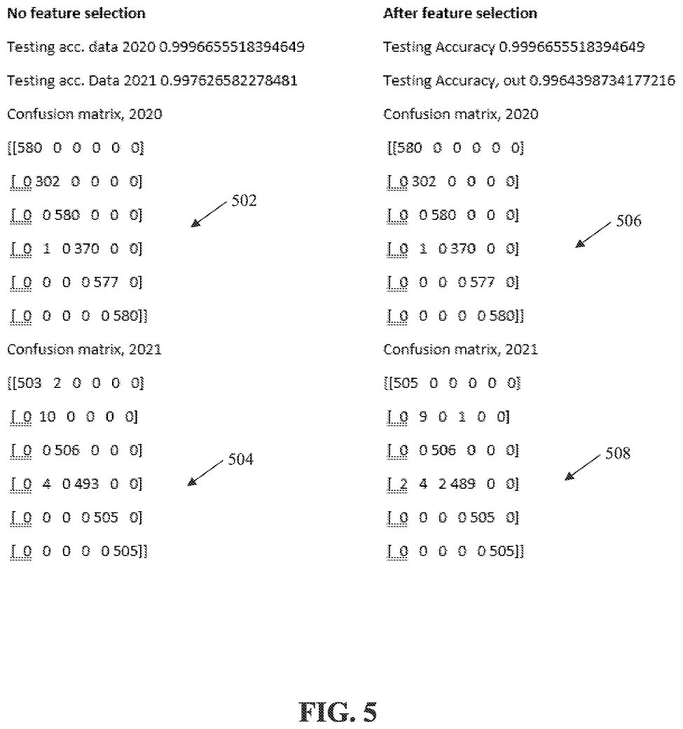

Reference is made to FIG. 5, which is a schematic of multiple confusion matrices created for an ML model trained on a training dataset that excludes data from the two devices that were confused, in accordance with some embodiments of the present invention.

Another random forest model was trained on the training dataset where data from the two devices that were confused (by the preceding random forest model) was removed.

Confusion matrix 502 is created for the ML model trained on the full set of features, using 2020 training data that excludes data of the two devices that were confused.

Confusion matrix 504 is created for the ML model trained on the full set of features, using 2021 training data that excludes data of the two devices that were confused.

Confusion matrix 506 is created for the ML model trained on a subset of selected features, using 2020 training data that excludes data of the two devices that were confused. Feature selection by the quantum annealer was applied to the features extracted from the data of the devices that excludes the two devices that were confused.

Confusion matrix 508 is created for the ML model trained on a subset of selected features, using 2021 training data that excludes data of the two devices that were confused. Feature selection by the quantum annealer was applied to the features extracted from the data of the devices that excludes the two devices that were confused.

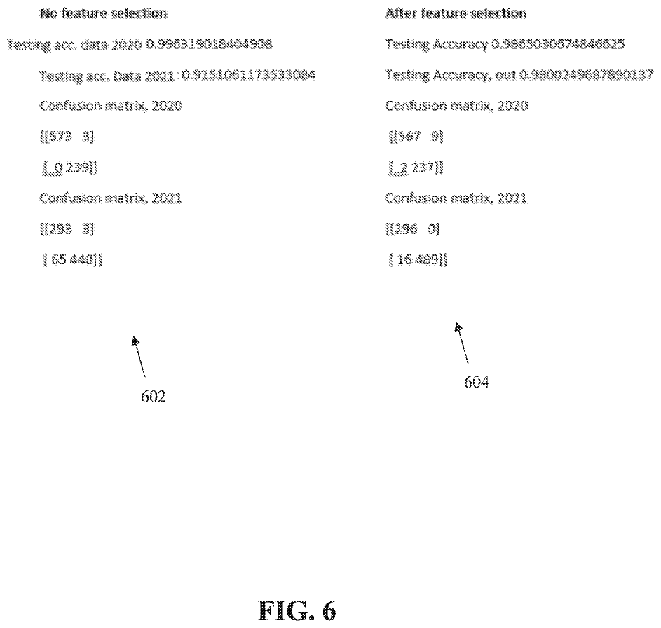

Reference is now made to FIG. 6, which is a schematic of two confusion matrices created for an ML model trained on a training dataset of data from the two devices that were confused, in accordance with some embodiments of the present invention.

Yet another random forest model was trained on a training dataset created from data of the two devices that were confused, i.e., of only the two devices and excluding data from other devices.

Confusion matrix 602 is created for the ML model trained on the full set of features, using training dataset of only the two devices that were confused.

Confusion matrix 604 is created for the ML model trained on a subset of selected features, using training dataset of only the two devices that were confused. Feature selection by the quantum annealer was applied to the features extracted from the data of the two devices that were confused.

It is noted that the ML model is able to accurately distinguish between the two devices that were confused by the preceding ML model.

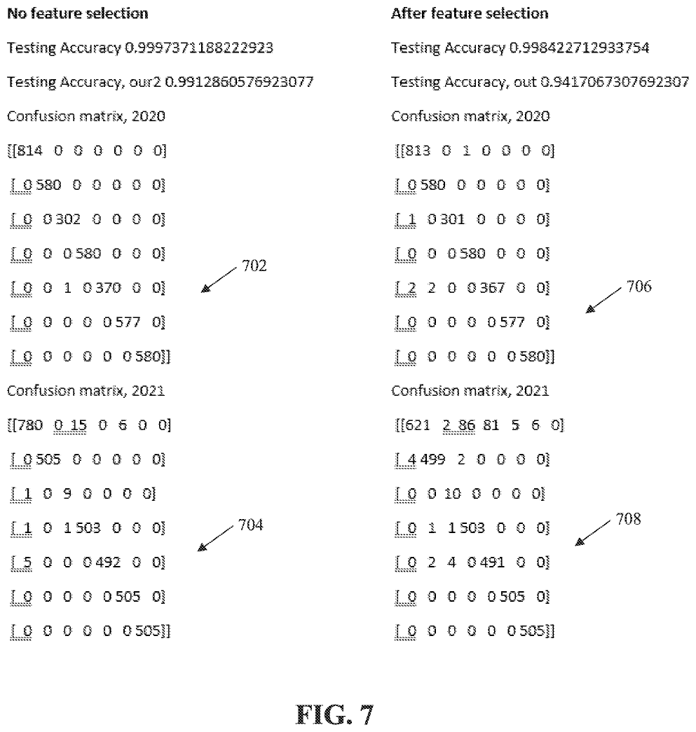

Reference is now made to FIG. 7, which is a schematic of multiple confusion matrices created for an ML model ensemble that includes a first ML model component trained to distinguish between multiple devices for which two devices are inaccurately classified, and a second ML model component trained to distinguish between the two devices that are inaccurately classified by the first ML model component, in accordance with some embodiments of the present invention.

Confusion matrix 702 is created for the ML model ensemble trained on the full set of features, using 2020 training data.

Confusion matrix 704 is created for the ML model ensemble trained on the full set of features, using 2021 training data.

Confusion matrix 706 is created for the ML model ensemble trained on a subset of selected features, using 2020 training data.

Confusion matrix 708 is created for the ML model ensemble trained on a subset of selected features, using 2021 training data.

The results show that the ML model ensemble with two ML model components represent two levels of classification obtains a better accuracy than the single ML model trained to classify into one of the multiple devices.

It is noted that the ML model ensemble created using selected features has a good accuracy of classification compared to the ML model ensemble created using the full set of features, indicating that performance of a computing device executing ML models can be improved by reducing the number of features without compromising accuracy of classification.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant machine learning models and optimization engines such as quantum annealer, will be developed and the scope of the terms ML model, optimization engine, and quantum annealer are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A computer implemented method of generating a reduced version of a ML model, comprising:
obtaining a sample dataset;
extracting a plurality of global features from the sample dataset;
applying a feature selection process for selecting a first subset of the plurality of global features;
analyzing a classification performance of the ML model fed the first subset, to identify an error in classification by the ML model;
identifying a subset of the sample dataset related to the error;
extracting a plurality of second features from the subset of the sample data;
applying the feature selection process for selecting a second subset of the plurality of second features; and
creating a reduced version of the ML model, comprising an ensemble of: a first ML model component trained by applying the first subset of the plurality of global features to the sample dataset, and a second ML model component trained by applying the second subset of the plurality of features to the subset of the sample data related to the error.

2. The computer implemented method of claim 1, wherein during inference, input data is first fed into the first ML model component to obtain a classification outcome, and in response to the classification outcome denoting the error in classification comprising ambiguity in the classification outcome, the input data is fed into the second ML model component to obtain a resolution to the classification outcome.

3. The computer implemented method of claim 1, wherein the feature selection process comprises defining a target function according to the plurality of global features or second features and a correlation with an expected outcome of the ML model being fed the plurality of global features or second features, and finding a minimum of the target function, the minimum representing the first subset or the second subset.

4. The computer implemented method of claim 3, further comprising applying a quantum annealer based process for finding the minimum of the cost function.

5. The computer implemented method of claim 1, wherein the error comprises at least two classification categories of a plurality of classification categories for which the ML model performance incorrect classification at a rate above a threshold, wherein the input data is fed into the second ML model component when the first ML model component classifies input data into the at least two classification categories, wherein the second ML model component classifies the input data into one of the at least two classification categories.

6. The computer implemented method of claim 5, wherein the at least two classification categories are merged into a single classification category, and the first ML model component is trained to classify the input data into the single classification category or other classification categories of the plurality of classification categories.

7. The computer implemented method of claim 6, wherein the second ML model component resolves ambiguity of the single classification category by classifying the input data into one of the at least two classification categories merged into the single classification category.

8. The computer implemented method of claim 1, further comprising computing a confusion matrix of the ML model fed the first subset to identify the error.

9. The computer implemented method of claim 1, further comprising:
measuring a baseline classification performance of the ML model fed the plurality of global features;
measuring the classification performance of the ML model fed the first subset;
evaluating the classification performance of the ML model fed the first subset relative to the baseline classification performance to determine significant degradation in performance; and
wherein the identification of the error in classification is in response to the determination of significant degradation in performance.

10. The computer implemented method of claim 1, further comprising:
analyzing the classification performance of the second ML model component fed the second subset, to identify a second error in classification by the second ML model component;
identifying a second subset of the sample dataset related to the second error;
extracting a plurality of third features from the second subset of the sample data;
applying the feature selection process for selecting a third subset of the plurality of third features; and
creating a third ML model component for inclusion in the reduced version of the ML model, the third ML model component trained by applying the third subset of features to the sample dataset, wherein input data is fed into the third ML model component when the second ML model component performs the second error in classification.

11. The computer implemented method of claim 1, further comprising:
iterating the analyzing the classification performance, the identifying the subset, the extracting, the applying the feature selection process, and the creating the reduced version, for creating a hierarchical tree of ML model components, wherein each lower level ML model component is for resolving classification ambiguity of a higher level ML model component.

12. The computer implemented method of claim 1, wherein the plurality of second features are the same as the plurality of global features.

13. A computer implemented method of inference by a reduced version of a ML model, comprising:
obtaining input data;
extracting a first subset of features from the input data;
feeding the first subset of features into a first ML model component of the reduced version of the ML model;
obtaining a first classification outcome from the first ML model component;
analyzing the first classification outcome to determine whether an error in classification occurred,
in response to determining the error, extracting a second subset of features from the input data;
feeding the second subset of features into a second ML model component of the reduced version of the ML model;
and obtaining a second classification outcome comprising a resolution to the error of the first classification outcome from the second ML model,
wherein the reduced version of the ML model is created according to claim 1.

14. The computer implemented method of claim 13, wherein the error in classification occurred when the first classification outcome comprises a single classification category representing a merger of a plurality of different classification categories, wherein the first ML model component is unable to accurately classify into one of the plurality of different classification categories, wherein the second ML model component accurately classifies into one of the plurality of different classification categories.

15. A system for generating a reduced version of a ML model, comprising:
at least one processor executing a code for:
obtaining a sample dataset;
extracting a plurality of global features from the sample dataset;
applying a feature selection process for selecting a first subset of the plurality of global features;
analyzing a classification performance of the ML model fed the first subset, to identify an error in classification by the ML model;
identifying a subset of the sample dataset related to the error;
extracting a plurality of second features from the subset of the sample data;
applying the feature selection process for selecting a second subset of the plurality of second features; and
creating a reduced version of the ML model, comprising an ensemble of: a first ML model component trained by applying the first subset of the plurality of global features to the sample dataset, and a second ML model component trained by applying the second subset of the plurality of features to the subset of the sample data related to the error.
